(19) United States
(12) Patent Application Publication
(10) Pub. No.: US 2025/0038337 A1
(43) Pub. Date: Jan. 30, 2025

(54) Cover Element in Sandwich Design having a Fusible Intermediate Layer for a Battery Housing, Battery Housing and Motor Vehicle

(71) Applicants: Audi AG, Ingolstadt (DE); ElringKlinger AG, Dettingen/Erms (DE)

(72) Inventors: Martin Schüssler, Kösching (DE); Markus Thurmeier, Adlkofen (DE); Anja Jäschke, Beilngries (DE); Thomas Wolf, Göppingen (DE)

(21) Appl. No.: 18/716,075

(22) PCT Filed: Dec. 8, 2022
(86) PCT No.: PCT/EP2022/084919

§ 371 Date: Jun. 3, 2024

(30) Foreign Application Priority Data
Dec. 13, 2021 (DE) 10 2021 214 245.1

(51) Int. Cl. H01M 50/282; H01M 50/231; H01M 50/249; H01M 50/28; H01M 50/342; H01M 50/367

(52) U.S. Cl. CPC H01M 50/282; H01M 50/231; H01M 50/249; H01M 50/28; H01M 50/3425; H01M 50/367; H01M 2220/20

(57) ABSTRACT

Described is a cover element for a battery housing of a battery storage device, in particular a high-voltage battery, including a plurality of battery cells, of an at least partially electrically driven motor vehicle. The cover element has a sandwich design including a first cover layer, a second cover layer, and an intermediate layer arranged between the cover layers. When the cover element is mounted on the battery housing, the first cover layer faces the battery storage device and the second cover layer faces away from the battery storage device. The first cover layer has a plurality of breaking portions which are movable relative to the first cover layer according to a pressure prevailing in a region of a relevant breaking portion, so that a break opening is formed, Also described in the context of the cover element is a battery housing and a motor vehicle.

### TECHNICAL FIELD

The invention relates to a cover element for a battery housing of a battery storage device, in particular, a high-voltage battery, which includes a plurality of battery cells, of an at least partially electrically driven motor vehicle, wherein the cover element has a sandwich design comprising a first cover layer, a second cover layer and an intermediate layer arranged between the cover layers, wherein, when the cover element is mounted on the battery housing, the first cover layer faces the battery storage device and the second cover layer faces away from the battery storage device.

### BACKGROUND

It is known from DE 10 2017 212 223 A1 to provide a material-free or hollow cell degassing space between a cooling plate of a battery module and an underbody protective coating. Regarding the state of the art as far as battery housings are concerned, reference is further made to the following published documents: DE 10 2009 020 185 A1, WO 2014 195 048 A1, WO 2021 012 912 A1, EP 3 772120 B1, U.S. Pat. No. 20,150,140 369 A1, JP 2016 110 881 A and WO 2021 022 130 A1.

The problem with currently available battery housings for high-voltage batteries for motor vehicles is that, in the rare case of a battery cell failing, it is not possible to discharge hot gas or hot fluid in a directed manner. Until now, this problem has been tackled by separating battery housings from the interior of the motor vehicle by means of additional fire protection panels to prevent hot fluid from entering the interior. Although such fire protection panels offer effective and efficient protection, they are of significant weight, which is disadvantageous with regard to the total mass of the motor vehicle to be moved. Furthermore, the manufacture and installation of fire protection panels is associated with correspondingly high costs.

### SUMMARY

The object underlying the invention is to provide a cover element which can avoid the aforementioned disadvantages, in particular, that the use of additional fire protection panels is no longer necessary.

This object is achieved by a cover element, a battery housing and a motor vehicle with the features of the respective independent claims. Advantageous embodiments with suitable further developments are stated in the dependent claims.

Hence, a cover element for a battery housing of a battery storage device, in particular, a high-voltage battery, is proposed which includes a plurality of battery cells, of an at least partially electrically driven motor vehicle, wherein the cover element has a sandwich design comprising a first cover layer, a second cover layer and an intermediate layer arranged between the cover layers, wherein, when the cover element is mounted on the battery housing, the first cover layer faces the battery storage device and the second cover layer faces away from the battery storage device. In this process, it is provided that the first cover layer has a plurality of rupture sections which are movable relative to the first cover layer contingent on pressure prevailing in the area of a particular rupture section, so that a rupture opening is formed.

By means of the rupture sections, the first cover layer of the cover element is designed in such a manner that hot fluid escaping under pressure from a particular battery cell can be introduced into the cover element. In this process, the open rupture section serves as a directing element for the fluid flow, at least during an initial phase of the exit of hot fluid.

In the cover element, the rupture sections can be designed in such a manner that, through a particular bursting opening, a hot fluid flow from a battery cell corresponding to the rupture opening can be introduced into the intermediate layer. In particular, the rupture sections in the first cover layer can be provided or arranged corresponding to degassing openings in the battery cells, so that any hot fluid exiting from the degassing openings exerts pressure directly on the rupture section, so that the rupture opening in the first cover layer is released for the hot fluid to exit into the intermediate layer of the cover element.

In this process, the intermediate layer can be designed in such a manner that it is at least partially fused when the hot fluid flow is introduced, so that a discharge channel can be formed within the intermediate layer.

In other words, the hot fluid exiting from a particular battery cell is introduced into the intermediate layer between the two cover layers, with the intermediate layer being at least partially fused so that the hot fluid can flow out in a directed manner between the two cover layers inside the cover element and be directed away from the battery cell.

In the cover element, the first cover layer or/and the second cover layer include a fabric, wherein preferably the fibers of the fabric contain glass or/and aramid or/and carbon or/and basalt or consist of at least one of these materials. The first cover layer or/and the second cover layer can also include tape layers. By using a fabric, in particular, made of the materials or material combinations specified above, the cover layers are resistant to heat, so that hot fluid can be reliably directed between the cover layers, with the intermediate layers being at least partially fused.

In the cover element, the intermediate layer can be made of a thermosetting or thermoplastic plastic material. In particular, the intermediate layer can also have cavities or be foamed, which simplifies the introduction of hot fluid and enables a desired fusing of the plastic material.

The cover element, in the area of a particular rupture section, can include at least one support element which extends from the first cover layer to the battery storage device. By means of one or more such support elements, the rupture section can, in the mounted state, be supported on the battery storage device or on a particular battery cell, so that the rupture section is arranged in a desired target position relative to the battery storage device.

For the cover element, the support elements can be made of a material that has a greater temperature resistance than the intermediate layer. This makes it possible for the support elements to be able to at least initially direct the hot fluid exiting from the battery cell in the direction of the rupture section or the rupture opening. If the support sections are connected to the respective rupture section, they can be moved together with it relative to the first cover layer.

In the cover element, the intermediate layer can be made of a foamed thermoplastic or thermosetting material, in particular, selected from polypropylene (PP), polyamide (PA), polyethylene (PE) or polyurethane (PU) and the like.

The intermediate layer can be open-cell or closed-cell foamed. An open-cell foamed intermediate layer can support the expansion or outflow of hot gas.

Alternatively, the intermediate layer can be designed as a honeycomb-like structure in the cover element, wherein the honeycomb-like structure is made of a thermoplastic or thermosetting material, in particular, selected from polypropylene (PP), polyamide (PA) or polyethylene (PE).

The honeycomb-like structure can be designed in such a manner that the honeycombs extend between the first and second cover layers or are aligned essentially orthogonally to the two cover layers.

In the cover element, the first cover layer or/and the second cover layer can be made of a thermoplastic or thermosetting material, in particular, selected from polypropylene (PP), polyamide (PA), polycarbonate (PC) or polyphthalamide (PPA). The cover layers can also be made of thermoplastic matrix materials.

For the cover element, the sandwich design comprising the first cover layer, the second cover layer and the intermediate layer can be produced by means of an injection molding process.

Such a method, for example, can comprise the following steps: providing the first cover layer and the second cover layer on respective mold halves of an injection mold; closing the injection mold and injecting plastic masses between the two cover layers to form the intermediate layer. If the intermediate layer is to be designed with cavities or is to have a foamed structure, the mold halves can be moved slightly away from each other after the plastic material has been injected, so that the injected plastic material can expand, forming cavities.

To ensure that hot fluid can be discharged reliably within the intermediate layer, it is additionally possible to produce a compact, in particular, non-foamed, directing layer from the plastic material in the course of the injection molding process. Such a directing layer, for example, can be provided approximately in the middle between the two cover layers. Alternatively, it can also be arranged closer to the second cover layer. The provision of such a directing layer supports the introduction of hot fluid into a specific or desired area of the intermediate layer, as the exiting hot fluid expands more easily in foamed areas of the intermediate layer and fuses the foamed plastic material there more quickly. The compact directing layer thus serves as an additional protective layer that is not completely fused immediately.

In a battery housing comprising a battery storage device accommodated therein, in particular, a high-voltage battery which includes a plurality of battery cells, wherein the battery housing includes a base element and a top element, which are connected to side wall elements, the base element or the top element can be designed as the cover element described above.

For a motor vehicle comprising an at least partially electric drive and a battery storage device, in particular, a high-voltage battery, the battery storage device can be accommodated within such a battery housing, wherein the battery housing is arranged below a floor panel of a body of the motor vehicle.

### BRIEF DESCRIPTION OF THE DRAWINGS

Further advantages and details of the invention emerge from the following description of embodiments with reference to the figures, in which:

FIG. 1 shows a simplified and schematic sectional view of a battery housing with battery cells and a cover element;

FIG. 2 shows a simplified and schematic, slightly enlarged partial illustration according to the dashed rectangle II of FIG. 1 when hot fluid exits from a battery cell;

FIG. 3 shows a simplified and schematic top view of part of a cover element with rupture sections;

FIG. 4 shows a simplified and schematic sectional view of an embodiment of a cover element.

### DETAILED DESCRIPTION

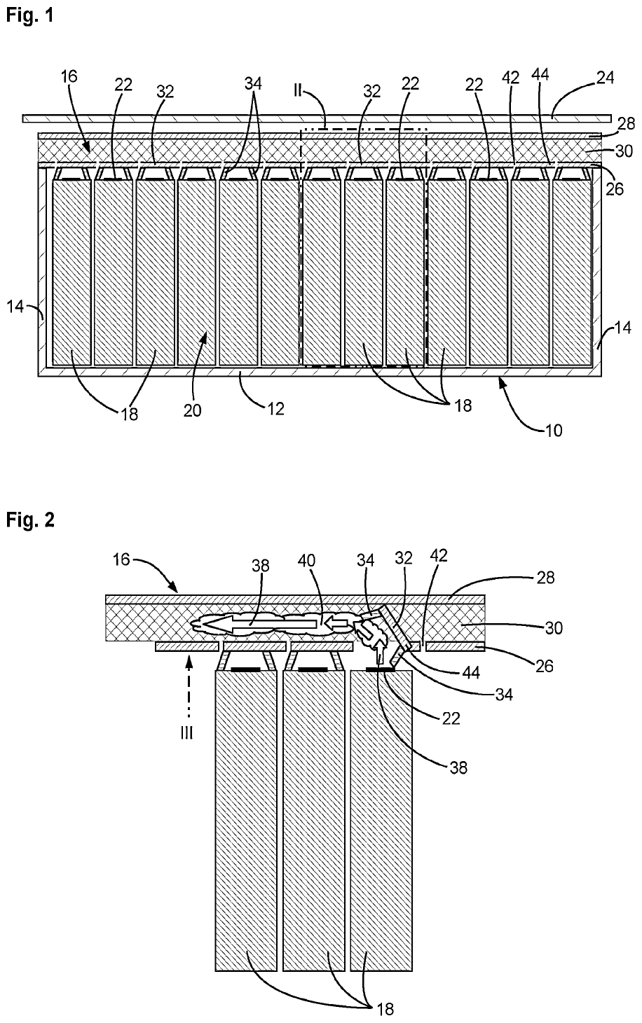

FIG. 1 shows a simplified and schematic sectional view of a battery housing 10. The battery housing 10 has a base element 12, side wall elements 14 and a cover element 16. The cover element 16 is exemplarily configured therein as a cover element.

The battery housing 10 depicts in simplified form a plurality of battery cells 18 accommodated therein, which together form a battery storage device 20, in particular, a high-voltage battery. Each battery cell 18 has a degassing opening 22, which is illustrated in simplified form as a thicker, black line.

The battery housing 10 can be arranged below a floor panel 24 of a motor vehicle that is otherwise not shown further. In particular, the motor vehicle can be partially or fully electrically powered, using energy stored in the battery cells 18. The floor panel 24 of the motor vehicle depicted therein separates the battery storage device 20 from an interior of the motor vehicle located above the floor panel 24.

The cover element 16 has a sandwich design comprising a first cover layer 26, a second cover layer 28 and an intermediate layer 30 arranged between the cover layers. When the cover element 16 is mounted on the battery housing 10 as depicted therein, the first cover layer 26 faces the battery storage device 20 and the second cover layer 28 faces away from the battery storage device.

It should be noted that the cover element 16 shown therein as a top element could alternatively also be used as a base element of the battery housing 10, provided that the degassing openings 22 of the battery cells are each arranged at the bottom.

It can further be seen from FIG. 1 that the first cover layer 26 has a plurality of rupture sections 32. At least one support element 34 can be provided in the area of a particular rupture section 32, which extends from the first cover layer 26 to the battery storage device 20 or a respective battery cell 18.

With reference to the slightly enlarged sectional view of part of FIG. 1 (approximately corresponding to the dot-dashed rectangle II of FIG. 1), the properties and functions of the cover element 16 are described in more detail.

In the cover element 16, the rupture sections 32 are designed in such a manner that they are movable relative to the first cover layer 26 contingent on pressure prevailing, so that a rupture opening 36 can be formed. FIG. 2 illustrates by way of example that the battery cell 18 depicted on the right-hand side allows hot fluid 38 (illustrated by contour arrows) to escape through the degassing opening 22. During such degassing of a battery cell 18, hot fluid, which can have a temperature of several hundred degrees Celsius, exits during a short period of about 5 to 20 seconds.

The hot fluid 36 escaping from the battery cell 18 increases the pressure locally in the area of the particular rupture section 32, so that the rupture section 32 of the first cover layer 26 is pressed or moved in the direction of the intermediate layer 30. The rupture sections 32 are thus designed in such a manner that, through a particular rupture opening 36, the hot fluid flow 38 from a battery cell 18 corresponding to the rupture opening 36 can be introduced into the intermediate layer 30.

As can further be seen from FIG. 2, the intermediate layer 30 is designed in such a manner that it is at least partially fused when the hot fluid flow 38 is introduced, which is illustrated by the cloudy white area. As a result, a discharge channel 40 is formed in the intermediate layer, through which the hot fluid 38 can be discharged in a targeted or directed manner.

The first cover layer 26 or/and the second cover layer 28 include a fabric, wherein the fibers of the fabric contain, for example, glass or/and aramid or/and carbon or/and basalt or consist of at least one of these materials. The cover layers 26, 28 thus, in particular, contain materials that can withstand high temperatures for a longer period of time.

The intermediate layer 30 is made of a thermosetting or thermoplastic plastic material. This thermosetting or thermoplastic plastic material can be fused by the hot fluid 38, forming the discharge channel 40 already mentioned above. The hot fluid 38 can thus be discharged reliably between the two cover layers 26, 28.

The support elements 34 assigned to a respective rupture section 32 can be made of a material that has a greater temperature resistance than the intermediate layer 30. As can be seen from FIG. 2, the support elements 34 can assume a kind of directing function for the exiting hot fluid 38, at least for a certain period of time.

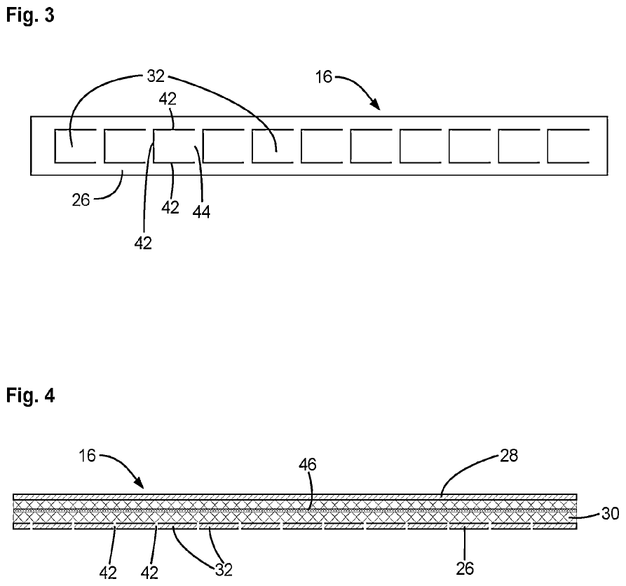

FIG. 3 shows a schematic and simplified top view from below of the first cover layer 26, approximately corresponding to arrow III of FIG. 2. The rupture sections 32 arranged within the cover layer 26 can be seen from the illustration. The rupture sections 32, for example, can be produced by respective incisions 42 made in the cover layer 26. In the example shown, each rupture section 32 is formed by three incisions 42 in such a manner that the respective rupture section 32 has a hinge section 44 which enables the pressure-dependent movement or folding open of the rupture section 32.

For the cover element 16, the sandwich design comprising the first cover layer 26, the second cover layer 28 and the intermediate layer 30 can, for example, be produced by means of an injection molding process.

Such a method, for example, can comprise the following steps: providing the first cover layer 26 and the second cover layer 28 on respective mold halves of an injection mold; closing the injection mold and injecting a plastic mass between the two cover layers 26, 28 to form the intermediate layer 30. If the intermediate layer 30 is to be designed with cavities or is to have a foamed structure, the mold halves can be moved slightly away from each other after the plastic material has been injected, so that the injected plastic material can expand, forming cavities.

To ensure that hot fluid 38 (FIG. 2) can be discharged reliably within the intermediate layer 30, it is additionally possible to produce a compact, in particular, non-foamed, directing layer 46 from the plastic material in the course of the injection molding process. Such an optional configuration of the cover element 16 is shown in FIG. 4. Such a directing layer 46, for example, can be provided approximately in the middle between the two cover layers 26, 28. Alternatively, it can also be arranged closer to the second cover layer 28. The provision of such a directing layer 46 supports the introduction of hot fluid 38 into a specific or desired area of the intermediate layer 30, as the exiting hot fluid 38 expands more easily in foamed areas of the intermediate layer 30 and fuses the foamed plastic material there more quickly. The compact directing layer 46 thus serves as an additional protective layer that is not completely fused immediately.

In order to avoid repetition, reference is made to the above introduction to the description with regard to possible materials of the intermediate layer 30 and the two cover layers 26, 28.

1-14. (canceled)

15. A cover element for a battery housing of a battery storage device of an at least partially electrically driven motor vehicle and which includes a plurality of battery cells, the cover element comprising:
a first cover layer;
a second cover layer; and
an intermediate layer arranged between the first cover layer and the second cover layer in a sandwich design,
wherein when the cover element is mounted on the battery housing, the first cover layer faces the battery storage device and the second cover layer faces away from the battery storage device,
wherein the first cover layer comprises a plurality of rupture sections which are movable relative to the first cover layer contingent on pressure prevailing in an area of a particular rupture section, so that a rupture opening is formed.

16. The cover element of claim 15, wherein the rupture sections are designed such that, through a particular rupture opening, a hot fluid flow from a battery cell corresponding to the rupture opening can be introduced into the intermediate layer.

17. The cover element of claim 16, wherein the intermediate layer is designed such that the intermediate layer is at least partially fused when the hot fluid flow is introduced, so that a discharge channel is formed within the intermediate layer.

18. The cover element of claim 15, wherein the first cover layer or/and the second cover layer comprise a fabric.

19. The cover element of claim 18, wherein fibers of the fabric contain glass or/and aramid or/and carbon or/and basalt or consist of at least one of these materials.

20. The cover element of claim 15, wherein the intermediate layer is made of a thermosetting or thermoplastic plastic material.

21. The cover element of claim 15, wherein in the area of a particular rupture section, the cover element includes at least one support element which extends from the first cover layer to the battery storage device.

22. The cover element of claim 21, wherein the at least one support element is made of a material which has a greater temperature resistance than the intermediate layer.

23. The cover element of claim 15, wherein the intermediate layer is made of a foamed thermoplastic or thermosetting material.

24. The cover element of claim 23, wherein the foamed thermoplastic or thermosetting material is polypropylene, polyamide, polyethylene, or polyurethane.

25. The cover element of claim 23, wherein the intermediate layer is open-cell or closed-cell foamed.

26. The cover element of claim 15, wherein the intermediate layer has a honeycomb-like structure, and wherein the honeycomb-like structure is made of a thermoplastic or thermosetting material.

27. The cover element of claim 26, wherein the thermoplastic or thermosetting material is polypropylene, polyamide or polyethylene.

28. The cover element of claim 15, wherein the first cover layer or/and the second cover layer is made of a thermoplastic or thermosetting material.

29. The cover element of claim 18, wherein the thermoplastic or thermosetting material is polypropylene, polyamide, polycarbonate, or polyphthalamide.

30. The cover element of claim 15, wherein the sandwich design is an injection molded design.

31. A battery housing for accommodating a battery storage device of an at least partially electrically driven motor vehicle and which includes a plurality of battery cells, the battery housing comprising:
a base element and a top element connected to side wall elements,
wherein the base element or the top element is designed as a cover element,
wherein the cover element comprises a first cover layer, a second cover layer, and an intermediate layer arranged between the first cover layer and the second cover layer in a sandwich design,
wherein when the cover element is mounted on the battery housing, the first cover layer faces the battery storage device and the second cover layer faces away from the battery storage device,
wherein the first cover layer comprises a plurality of rupture sections which are movable relative to the first cover layer contingent on pressure prevailing in an area of a particular rupture section, so that a rupture opening is formed.

32. A motor vehicle, comprising:
an at least partially electric drive;
a battery housing arranged below a floor panel of a body of the motor vehicle; and
a battery storage device accommodated within the battery housing,
wherein the battery housing comprises a base element and a top element connected to side wall elements,
wherein the base element or the top element is designed as a cover element,
wherein the cover element comprises a first cover layer, a second cover layer, and an intermediate layer arranged between the first cover layer and the second cover layer in a sandwich design,
wherein the cover element is mounted on the battery housing such that the first cover layer faces the battery storage device and the second cover layer faces away from the battery storage device,
wherein the first cover layer comprises a plurality of rupture sections which are movable relative to the first cover layer contingent on pressure prevailing in an area of a particular rupture section, so that a rupture opening is formed.
